(19) United States
(12) Patent Application Publication
(10) Pub. No.: US 2024/0254333 A1
(43) Pub. Date: Aug. 1, 2024

(54) PHOTOCURABLE URETHANE GEL-STATE BODY AND METHOD FOR PRODUCING SAME

(71) Applicant: TAISEI KOGYO CO., LTD., Tokyo (JP)

(72) Inventors: Yasuo MUKAI, Tokyo (JP); Atsushi KOYAMA, Kanagawa (JP)

(21) Appl. No.: 18/560,927

(22) PCT Filed: Dec. 7, 2022
(86) PCT No.: PCT/JP2022/045010

§ 371 Date: Nov. 15, 2023

(30) Foreign Application Priority Data
Feb. 15, 2022 (JP) 2022-021407

(51) Int. Cl. C08L 75/16; C08F 299/06; C08G 18/67; C08K 5/00; C08K 5/5397

(52) U.S. Cl. CPC C08L 75/16; C08F 299/06; C08G 18/672; C08K 5/0025; C08K 5/5397; C08G 2190/00; C08L 2205/025; C08L 2312/06

(57) ABSTRACT

There is provided a photocurable urethane gel-state body which has self-formability of being in a gum-state and conforming to a shape of a surface to be used by a first-stage curing, and turns to a high-hardness polyurethane by a second-stage photocuring with the self formed shape being held. The present invention relates to the photocurable urethane gel-state body which is a photocurable gel-state body containing, at least, a photocurable composition (A) containing a polyfunctional urethane (meth)acrylate and a photopolymerization initiator, and a polyurethane (B), wherein the photocurable composition (A): the polyurethane (B) is, in mass ratio, in the range of 25:75 to 55:45; and the polyfunctional urethane (meth)acrylate has no residual hydroxyl group, and to a method for producing the photocurable urethane gel-state body.

### CROSS REFERENCE TO RELATED APPLICATION

The present application claims priority based on Japanese Patent Application No. 2022-021407, filed on Feb. 15, 2022 in Japan, the contents of which are hereby incorporated by reference.

### TECHNICAL FIELD

The present invention relates to a photocurable urethane gel-state body, and a method for producing the same.

### BACKGROUND ART

Polyurethane is a generic term of polymers having urethane bonds, and is utilized in various forms such as foams, elastomers, adhesives, coating materials, binders and synthetic leather. For example, elastomers of polyurethane are excellent in elasticity, mechanical strength, oil resistance, abrasion resistance, weather resistance and the like, and are used for cushioning materials, vehicular sheets, sealing materials, industrial roll materials, packing materials and the like.

Polyurethane has a wide variety of kinds and also includes polyurethanes having a property of thermoplasticity, thermocurability or photocurability. As a method for producing a polyurethane, a method is known in which the polymerization is carried out by dual curing using a combination of photocuring and thermocuring (for example, see Patent Literature 1).

Then, in screw thread standards for existing pipe joints, there are, in addition to JIS, ISO, ANSI and the like, also ones for parallel threads, taper threads and the like according to applications, and the numbers of thread ridges, angles thereof and the like are different in some cases. Screw threads have a wide variety of kinds depending on economic blocs; hence, in the case where external thread sides and internal thread sides are not interchangeable, conversion joints become necessary.

When a resin-made tube or hose is attached to a screw hole of piping, a machine or the like, tightening by caulking, a telescopic socket or the like is usually used. Although one-touch joints enabling easier attachment/detachment of a tube or hose are often used, in any pipe joints, for holding the air tightness between the joint and the tube and between the joint and the screw hole, it is required to install a sealing mechanism to the joint itself, and to apply a sealing tape, sealing agent or the like to a screw portion of the joint. Further, the attaching work takes time.

Further, in repairing of piping and building materials, repairing method are conventionally used in which roughness and pits of damaged surfaces are unevenness corrected or sealed with a putty, and a primer is applied and a curable resin composition like a fiber-reinforced plastic (FRP) composition and a curing agent are blended and multilayerly applied. In recent years, however, with the advent of ultraviolet-curable FRP sheets, great simplification of site work of repairing has been promoted (for example, see Patent Literature 2).

### CITATION LIST

### Patent Literature

Patent Literature 1: Japanese Patent Laid-Open No. 2013-213175
Patent Literature 2: Japanese Patent Laid-Open No. 2005-120820

### SUMMARY OF INVENTION

### Technical Problem

The above-mentioned conversion joints, though being convenient joints enabling the connection of an external thread and an internal thread different in standard, bring about demerits of scarcity in the space for an attaching portion, an increase in the weight of the object and an increase in the number of parts. Hence, when the number of the connection portions becomes large, the demerits become unable to be disregarded.

Further, the above-mentioned one-touch joints, though being easy in attachment/detachment of a tube or hose, in screw connection work, the similar demerits arise as in the conversion joints and the like. The joints themselves need to have at least 5 or more parts, and in the case of use for liquids and the like, since liquid puddles and the like are generated in the joints, the structure thereof can be said to be unsuitable to worksites requiring pipe inside cleaning.

Further, although the ultraviolet-curable FRP sheets can greatly simplify a plurality of steps by reducing time and labor for blending of raw materials on worksites of repairing, in the case where the roughness and pits of repairing surfaces become large, unevenness correction with a putty becomes necessary.

In order to solve the above problems, the present inventor has taken into consideration a dual curing-type urethane-based composition described in Patent Literature 1 cited earlier, but the composition has been judged to be unusable due to the following problems. One problem is lowness of flexibility in the first-stage curing. The dual curing-type urethane-based composition described in Patent Literature 1, when having been subjected to the first-stage curing (photocuring), though being capable of being deformed to some degree, lacked flexibility. Another problem is lowness of hardness in the second-stage curing. The dual curing-type urethane-based composition described in Patent Literature 1, when being subjected to the second-stage curing (thermocuring) after the first-stage curing (photocuring), was low in hardness. Hence, the dual curing-type urethane-based composition described in Patent Literature 1 is unsuitable to specifications of being stuffed in openings of the joints and completely cured, and as substitutes for the ultraviolet-curable FRP sheets.

The present invention has been achieved in consideration of the above problems, and has an object to provide a photocurable urethane gel-state body which has self-formability of being in a gum(also referred to as gummy)-state and conforming to a shape of a surface to be used by a first-stage curing, and turns to a high-hardness polyurethane by a second-stage photocuring with the self formed shape being held.

### Solution to Problem

(1) A photocurable urethane gel-state body according to one embodiment in order to achieve the above object is a photocurable urethane gel-state body comprising, at least:
a photocurable composition (A) comprising a polyfunctional urethane (meth)acrylate and a photopolymerization initiator; and
a polyurethane (B),
wherein the photocurable composition (A): the polyurethane (B) is, in mass ratio, in the range of 25:75 to 55:45; and
the polyfunctional urethane (meth)acrylate has no residual hydroxyl group.

(2) In a photocurable urethane gel-state body according to another embodiment, preferably, the photocurable composition (A): the polyurethane (B) is, in mass ratio, in the range of 41:59 to 50:50.

(3) In a photocurable urethane gel-state body according to another embodiment, preferably, a weight-average molecular weight (Mw) of the polyfunctional urethane (meth)acrylate is 1,500 or higher and 2,000 or lower.

(4) In a photocurable urethane gel-state body according to another embodiment, preferably, the photopolymerization initiator is a bisacylphosphine oxide-based photopolymerization initiator.

(5) In a photocurable urethane gel-state body according to another embodiment, preferably, a hardness of the gel-state body by a type E durometer based on JIS K6253 is E3 or higher and E10 or lower, and a hardness of the gel-state body after being photocured by a type E durometer based on JIS K6253 becomes E75 or higher.

(6) A method for producing a photocurable urethane gel-state body according to one embodiment in order to achieve the above object is the method comprising using:
a photocurable composition comprising a polyfunctional urethane (meth)acrylate and a photopolymerization initiator; and
a thermocurable composition comprising, at least, a polyol compound, an isocyanate compound and an acrylate monomer as a hydroxyl group-imparting additive,
wherein the photocurable composition: the thermocurable composition is, in mass ratio, in the range of 25:75 to 55:45, and the method comprising:
a mixing step of mixing the thermocurable composition and the photocurable composition to prepare a mixture; and
a thermocuring step of thermocuring the mixture after the mixing step.

(7) In a method for producing a photocurable urethane gel-state body according to another embodiment, preferably, the photocurable composition: the thermocurable composition is, in mass ratio, in the range of 41:59 to 50:50.

(8) In a method for producing a photocurable urethane gel-state body according to another embodiment, preferably, the acrylate monomer is hydroxyethyl acrylate and/or pentaerythritol (tri/tetra)acrylate.

### Advantageous Effects of Invention

According to the present invention, there can be provided a photocurable urethane gel-state body which has self-formability of being in a gum-state and conforming to a shape of a surface to be used by a first-stage curing, and turns to a high-hardness polyurethane by a second-stage photocuring with the self formed shape being held.

### DESCRIPTION OF EMBODIMENTS

Hereinafter, embodiments of the present invention will be described. The embodiments described in the below do not limit the invention according to the claims. Not all of elements and combinations thereof described in the embodiments are essential for the solution to problem of the present invention.

### 1. Constitution of a Photocurable Urethane Gel-State Body

A photocurable urethane gel-state body (also referred to simply as “gel-state body”) according to this embodiment comprises, at least, a photocurable composition (A) comprising a polyfunctional urethane (meth)acrylate and a photopolymerization initiator, and a polyurethane (B).

The photocurable composition: the polyurethane is, in mass ratio, in the range of 25:75 to 55:45. The polyfunctional urethane (meth)acrylate is an oligomer or monomer having no residual hydroxyl group. The photocurable composition is a composition curable on irradiation of the gel-state body with light. The photocurable composition is in an uncured state in the gel-state body. On the other hand, the polyurethane is a polymer formed in the gel-state body. The gel-state body is in the state that the photocurable composition in an uncured state is impregnated in the polyurethane being a cured body, that is, a so-called gel-state semi-cured body. Hereinafter, (1) the photocurable composition, (2) the polyurethane and a thermocurable composition thereof before being cured, and (3) other additives will be described. Here, in the present application, “to” is used to include numerical values before and after the to.

### (1) Photocurable Composition

The photocurable composition according to this embodiment comprises, at least, a polyfunctional urethane (meth)acrylate and a photopolymerization initiator (also referred to as “photoinitiator”).

### (1-a) Polyfunctional Urethane (Meth)Acrylate

The polyfunctional urethane (meth)acrylate has urethane bonds made by reacting an isocyanate group and a hydroxyl group, and acrylic groups. The acrylic group is at least one of an acryloyl group and a methacryloyl group (also referred to as “methacroyl group”). The polyfunctional urethane (meth)acrylate is preferably an oligomer rather than a monomer. The oligomer has a relatively small number of linking units of a monomer, and means a polymer in which the number of the monomer is 2 or larger and about 1,000 or smaller. The polyfunctional urethane (meth)acrylate, since being “polyfunctional”, means one in which the number of functional groups (acrylic group, acryloyl group) is 2 or larger, preferably 3 or larger.

The polyfunctional urethane (meth)acrylate can be produced, for example, by esterifying a polyurethane oligomer obtained by a reaction of a polyether polyol or polyester polyol with an isocyanate compound, with (meth)acrylic acid. The polyfunctional urethane (meth)acrylate may be an aliphatic urethane (meth)acrylate, or may also be an aromatic urethane (meth) acrylate.

Examples of the polyether polyol include polyalkylene glycols such as polyethylene glycol, polypropylene glycol, polytetramethylene glycol, polybutylene glycol, polypentamethylene glycol and polyhexamethylene glycol, and besides, random or block copolymers of these polyalkylene glycols. Examples of the polyester polyol include polycondensates of a polyhydric alcohol and a polyvalent carboxylic acid or an anhydride thereof, and ring-opened polymers of cyclic esters (lactones).

Examples of the polyhydric alcohol include ethylene glycol, diethylene glycol, propylene glycol, dipropylene glycol, trimethylene glycol, 1,4-tetramethylenediol, 1,3-tetramethylenediol, 2-methyl-1,3-trimethylenediol, 1,5-pentamethylenediol, neopentylglycol, 1,6-hexamethylenediol, 3-methyl- 1,5-pentamethylenediol, 2,4-diethyl-1,5-pentamethylenediol, glycerol, trimethylolpropane, trimethylolethane, cyclohexanediols (1,4-cyclohexanediol and the like), bisphenols, and sugar alcohols.

Examples of the polyvalent carboxylic acid or the anhydride thereof include aliphatic dicarboxylic acids such as malonic acid, maleic acid, fumaric acid, succinic acid, glutaric acid, adipic acid, suberic acid, azelaic acid, sebacic acid and dodecanedioic acid; alicyclic dicarboxylic acids such as 1,4-cyclohexanedicarboxylic acid; and aromatic dicarboxylic acids such as terephthalic acid, isophthalic acid, orthophthalic acid, 2,6-naphthalenedicarboxylic acid, paraphenylenedicarboxylic acid and trimellitic acid. Examples of the cyclic ester include propiolactone, β-methyl-δ-valerolactone and ε-caprolactone.

Examples of the isocyanate compound include one or more among aliphatic or aromatic diisocyanates and polyisocyanates. Exemplary isocyanate compounds include aromatic polyisocyanates such as TDI (for example, 2,4-tolylene diisocyanate (2,4-TDI), 2,6-tolylene diisocyanate (2,6-TDI), MDI (for example, 4,4′-diphenylmethane diisocyanate (4,4′-MDI), 2,4′-diphenylmethane diisocyanate (2,4′-MDI), 1,4-phenylene diisocyanate, polymethylene polyphenylene polyisocyanate, xylylene diisocyanate (XDI), tetramethylxylylene diisocyanate (TMXDI), tolidine diisocyanate (TODI), 1,5-naphthalene diisocyanate (NDI) and triphenylmethane triisocyanate; aliphatic polyisocyanates such as hexamethylene diisocyanate (HDI), trimethylhexamethylene diisocyanate (TMHDI), lysine diisocyanate and norbornane diisocyanate methyl (NBDI); alicyclic polyisocyanates such as transcyclohexane-1,4-diisocyanate, isophorone diisocyanate (IPDI), bis(isocyanatomethyl)cyclohexane (H₆XDI) and dicyclohexylmethane diisocyanate (H₁₂MDI); and carbodiimide-modified polyisocyanates of the above polyisocyanates or isocyanurate-modified polyisocyanates thereof. These may be used singly in one kind thereof, or may be used concurrently in two or more kinds thereof. Among these examples, as the isocyanate compounds, more preferable are XDI, TDI, MDI, TMHDI, NDI, H₆XDI, H₁₂MDI, TMXDI, HDI, IPDI and NBDI; and among these, still more preferable are XDI, TDI, MDI, TMXDI and HDI.

The polyfunctional urethane (meth)acrylate to be used in this embodiment has no residual hydroxyl group. When hydroxyl groups remain in the polyfunctional urethane (meth)acrylate, since it becomes easy for gelation to be inhibited in production of the photocurable urethane gel-state body, the case is not preferable. Then, the weight-average molecular weight (Mw) of the polyfunctional urethane (meth)acrylate has no significant limitations, but is preferably 1,500 or higher and 2,000 or lower and more preferably 1,500 or higher and 1,800 or lower.

### (1-b) Photopolymerization Initiator

The photopolymerization initiator is a composition (component) which can initiate the radical polymerization of urethane (meth)acrylate by irradiation with light represented by visible light or ultraviolet light in the coexistence with the urethane (meth)acrylate. As the photopolymerization initiator, one or two or more of photopolymerization initiators can be used, for example, acetophenone compounds such as 4-phenoxydichloroacetophenone, diethoxyacetophenone, 2-hydroxy-2-methyl-1-phenylpropan-1-one, 1-(4-isopropylphenyl)-2-hydroxy-2-methylpropan-1-one, 1-hydroxycyclohexyl phenyl ketone, 4-(2-hydroxyethoxy)-phenyl(2-hydroxy-2-propyl) ketone, 2-methyl-[4-(methylthio)phenyl]-2-morpholino-1-propanone and 2,2-dimethoxy-2-phenylacetophenone; benzoin compounds such as benzoin, benzoin methyl ether, benzoin isoethyl ether, benzoin isopropyl ether and benzoin isobutyl ether; benzophenone compounds such as benzophenone, benzoylbenzoic acid, methyl benzoylbenzoate, 4-phenylbenzophenone, hydroxybenzophenone, 4-benzoyl-4′-methyldiphenyl sulfide and 3,3′-dimethyl-4-methoxybenzophenone; thioxanthone compounds such as thioxanthone, 2-chlorothioxanthone, 2,4-dichlorothioxanthone, 2-methylthioxanthone, 2,4-dimethylthioxanthone, 2,4-diethylthioxanthone, isopropylthioxanthone and 2,4-diisopropylthioxanthone; 4,4′-dimethylaminothioxanthone, 4,4′-diethylaminobenzophenone, α-acyloxime ester, benzil and methylbenzoyl formate (“Vicure 55”), and an anthraquinone compound such as 2-ethylanthraquinone; and acylphosphine oxide compounds such as diphenyl(2,4,6-trimethylbenzoyl)phosphine oxide and bis(2,4,6-trimethylbenzoyl)phenylphosphine oxide. Especially preferable photopolymerization initiators are acylphosphine oxide compounds; more preferable photopolymerization initiators are bisacylphosphine oxide-based photopolymerization initiators; and among these, an especially more preferable photopolymerization initiator is bis(2,4,6-trimethylbenzoyl)phenylphosphine oxide.

(2) Polyurethane and Thermocurable Composition Thereof Before being Cured

### (2-a) Polyurethane

The polyurethane is a polymer having urethane bonds, which corresponds to a solid material of the photocurable urethane gel-state body. The polyurethane can be synthesized by heating the following thermocurable composition.

### (2-b) Thermocurable Composition

The thermocurable composition according to this embodiment comprises, at least, a polyol compound (also referred to simply as “polyol”), an isocyanate compound (also referred to simply as “isocyanate”) and an acrylate monomer as a hydroxyl group-imparting additive.

(2-b-1) Polyol Compound

The polyol compound can be used without being especially limited as long as being a diol containing two hydroxyl groups or a polyol containing three or more hydroxyl groups. For example, a polyol, such as a polyether-based one, a polyester-based one, a polycarbonate-based one, an acrylic one, a polybutadiene-based one or a polyolefin-based one, or a polyol, such as a caprolactone-modified one, a polyesteramide one, a polyurethane one, an epoxy one, an epoxy-modified one, an alkyd-modified one, castor oil or a fluorine-containing one, may be used singly or may be concurrently used in two or more kinds thereof. The polyol is preferably one having a weight-average molecular weight in the range of 200 to 10,000.

Here, examples of the polyether polyols include polyols obtained by adding an alkylene oxide represented by ethylene oxide, propylene oxide, butylene oxide or polyoxytetramethylene oxide to a compound having at least two or more active hydrogen groups, as a starting raw material, such as: a polyhydric alcohol such as ethylene glycol, propylene glycol, butylene glycol, tetramethylene glycol, glycerol, trimethylolpropane, pentaerythritol, sorbitol or sucrose; an aliphatic amine compound such as ethylenediamine; an aromatic amine compound such as toluenediamine or diphenylmethane-4,4-diamine; or an alkanolamine such as ethanolamine or diethanolamine.

Examples of the polyester polyols include polycondensates of at least one selected from ethylene glycol, propylene glycol, butanediol, pentanediol, hexanediol, glycerol, 1,1,1-trimethylolpropane, other low-molecular polyols and the like with at least one selected from glutaric acid, adipic acid, pimelic acid, suberic acid, sebacic acid, dimer acids, other low-molecular aliphatic carboxylic acids and oligomer acids, and the like; and ring-opened polymers of propiolactone, valerolactone or the like.

Examples of the other polyols include polymer polyols and polycarbonate polyols; polybutadiene polyols; hydrogenated polybutadiene polyols; acrylic polyols; and low-molecular polyols such as ethylene glycol, diethylene glycol, propylene glycol, dipropylene glycol, butanediol, pentanediol and hexanediol.

(2-b-2) Isocyanate Compound

For example, a similar isocyanate compound as described in the above (1-a) Polyfunctional urethane (meth)acrylate can be used. Here, duplicated exemplifications will be omitted.

(2-b-3) Acrylate Monomer

The acrylate monomer to be used in this embodiment is also referred to as a hydroxyl group-containing acrylate ester. It does not matter whether the acrylate monomer is monofunctional or polyfunctional. Examples of the acrylate monomer include hydroxyethyl (meth)acrylate, hydroxypropyl (meth)acrylate, hydroxybutyl (meth)acrylate, caprolactone or alkylene oxide adducts of the above (meth)acrylates, glycerol mono(meth)acrylate, glycerol di(meth)acrylate, glycidyl methacrylate-acrylic acid adducts, trimethylolpropane mono(meth)acrylate, trimethylol di(meth)acrylate, pentaerythritol tri(meth)acrylate, pentaerythritol tetra(meth)acrylate, dipentaerythritol penta(meth)acrylate, ditrimethylolpropane tri(meth)acrylate and trimethylolpropane-alkylene oxide adducts-di(meth)acrylate, and combinations of two or more thereof. Among the above acrylate monomers, preferable are either one of hydroxyethyl acrylate and pentaerythritol (tri/tetra)acrylate, and combinations of two or more thereof; and more preferable are pentaerythritol (tri/tetra)acrylate. Here, the above “(meth)acrylate” means “methacrylate” and/or “acrylate”.

### (3) Other Additives

As a catalyst, an amine compound (triethylenediamine, bis(2-dimethylaminoethyl) ether, N,N,N′,N′-tetramethylhexamethylenediamine, or the like), or a metal-based catalyst (dibutyltin dilaurate, stannous octanoate, or the like) may be used. Further, in addition to the above catalyst, well-known additives, such as plasticizers, fillers (for example, inorganic fillers), colorants, stabilizers, preservatives, antioxidants and fluorine additives, may be added.

### 2. Preferable Amounts of Each Constituent of the Photocurable Urethane Gel-State Body

The mass ratio of the photocurable composition (A) and the polyurethane (B) constituting the photocurable urethane gel-state body is in the range of 25 (A): 75 (B) to 55 (A): 45 (B). A more preferable mass ratio thereof is in the range of 41 (A): 59 (B) to 50 (A): 50 (B). The polyurethane (B) is synthesized by a polyaddition reaction of a reaction product of a polyol compound (b1) and an acrylate monomer (b3) as a hydroxyl group-imparting agent, with an isocyanate compound (b2). Hence, the mass of the polyurethane (B) can be regarded to be equal to the sum total of each mass of the polyol compound (b1), the isocyanate compound (b2) and the acrylate monomer (b3).

The amount of the polyfunctional urethane (meth)acrylate (a1) contained in the photocurable urethane gel-state body is, with respect to 100 parts by mass of the total amount of the polyfunctional urethane (meth)acrylate (a1) and the photopolymerization initiator (a2), preferably 95.0 parts by mass or larger and 99.9 parts by mass or smaller, more preferably 97.0 parts by mass or larger and 99.7 parts by mass or smaller and still more preferably 98.0 parts by mass or larger and 99.5 parts by mass or smaller. The amount of the photopolymerization initiator (a2) contained in the photocurable composition is, with respect to 100 parts by mass of the total amount of the polyfunctional urethane (meth)acrylate (a1) and the photopolymerization initiator (a2), preferably 0.1 part by mass or larger and 5.0 parts by mass or smaller, more preferably 0.3 part by mass or larger and 3.0 parts by mass or smaller and still more preferably 0.5 part by mass or larger and 2.0 parts by mass or smaller.

3. Preferable amounts of each constituent in the photocurable urethane gel-state body before curing of the polyurethane

Preferable amounts of each constituent before curing of the polyurethane (B), that is, preferable amounts of the polyol compound (b1), the isocyanate compound (b2) and the acrylate monomer (b3) being a hydroxyl group-imparting additive, are as follows.

It is preferable that the polyol compound (b1): the isocyanate compound (b2) is, in the situation where the hydroxyl group-imparting additive has been added, in a proportion (OH:NCO) of effecting urethane bonds (—NH—CO—O—). That is, the isocyanate compound is, in the equivalence ratio (NCO/OH) to the hydroxyl value of the polyol compound containing the hydroxyl group-imparting additive added thereto, preferably 0.5 to 2.0 and more preferably 0.8 to 1.7. The amount of the acrylate monomer (b3) is, with respect to 100 parts by mass of the polyol compound (b1), preferably 0.5 part by mass or larger and 10.0 parts by mass or smaller, more preferably 1.0 part by mass or larger and 8.0 parts by mass or smaller and still more preferably 1.5 parts by mass or larger and 6.6 parts by mass or smaller.

### 4. Preferable Hardness of the Photocurable Urethane Gel-State Body

The hardness of the photocurable urethane gel-state body is, in a hardness by a type E durometer based on JIS K6253, preferably E1 or higher and E30 or lower and more preferably E3 or higher and E10 or lower. The photocurable urethane gel-state body in the above hardness range becomes suitable for the cases of being stuffed in screw holes and used as pipe joints, and being used as substitutes for ultraviolet-curable FRP sheets. In particular, in the case of using the gel-state body for attaching a tube in place of a one-touch joint, it is easy for the gel-state body to be stuffed in a screw hole being an attaching objective, and it is also easy for the tube to be inserted into and made to penetrate the gel-state body. Then, due to that the gel-state body has a suitable hardness and is not liquefied and can secure the sealability between the tube and the screw hole, the gel-state body is suitable for applications to pipe joints.

### 5. Method for Producing the Photocurable Urethane Gel-State Body

A method for producing the photocurable urethane gel-state body according to this embodiment uses the photocurable composition containing the polyfunctional urethane (meth)acrylate and the photopolymerization initiator, and the thermocurable composition containing, at least, a polyol compound, an isocyanate compound and an acrylate monomer as a hydroxyl group-imparting additive. The production method comprises a mixing step of mixing the thermocurable composition and the photocurable composition to prepare a mixture, and a thermocuring step of thermocuring the mixture after the mixing step. The photocurable composition: the thermocurable composition is, in mass ratio, in the range of 25:75 to 55:45. The photocurable composition the thermocurable composition is, in mass ratio, preferably in the range of 41:59 to 50:50. The acrylate monomer belonging to the thermocurable composition is preferably hydroxyethyl acrylate and/or pentaerythritol (tri/tetra)acrylate.

Then, a more specific and exemplary method for producing the photocurable urethane gel-state body will be described.

The photopolymerization initiator is dissolved in dehydrated acetone as a solvent. Then, the solution is added to the polyfunctional urethane (meth)acrylate. The mixture of the photopolymerization initiator, the polyfunctional urethane (meth)acrylate and the dehydrated acetone is heated at a temperature of 90 to 100° C. The photocurable composition is thus made.

On the other hand, the hydroxyl group-imparting additive (acrylate monomer) is added to the polyol compound being a base agent of the polyurethane, and mixed. As a result, acryloyl groups are introduced to the polyol compound. Then, to the mixture, the isocyanate compound being a curing agent is added and stirred. The thermocurable composition is thus made.

Then, the above-mentioned photocurable composition and thermocurable composition are stirred and mixed, and heated. The heating temperature is not limited as long as being a temperature at which the thermocurable composition is curable, but is preferably 80° C. or higher and 120° C. or lower and more preferably 90° C. or higher and 110° C. or lower. The mixture of the photocurable composition and the thermocurable composition is preferably put in a mold and then heated. The photocurable urethane gel-state body is thus made.

### 6. Method for Producing a Polyurethane, Using the Photocurable Urethane Gel-State Body

The photocurable urethane gel-state body is cured by using a light irradiation device which can irradiate visible light or ultraviolet light, to thereby become a polyurethane. The photocurable urethane gel-state body thermocured in the mold can be cured by being irradiated with light to the exposed surface of the gel-state body with the gel-state body being put in the mold. The deeper the curing depth, the better. For applications to pipe joints, it is preferable that the curing depth is 15 mm or larger. It is more preferable that the light irradiation device is one which can irradiate visible light and is in a small size.

### 7. Preferable Hardness of the Polyurethane

The hardness of the polyurethane after the photocurable urethane gel-state body has been cured is, in a hardness by a type E durometer based on JIS K6253, preferably E60 or higher and E100 or lower (E100 is the measurement limit), more preferably E70 or higher and E100 or lower and still more preferably E75 or higher and E100 or lower. For example, in the case where the photocurable urethane gel-state body is stuffed in a screw hole; a tube is inserted; and the gel-state body is photocured, when the polyurethane has the above-mentioned hardness, a tough pipe joint exhibiting no easy coming-out of the tube and the photocured body and withstanding long-term usage can be obtained.

### EXAMPLES

Examples of the present invention will be described in comparison with Comparative Examples. Then, the present invention is not any more limited to the following Examples.

### 1. Raw Materials

### (1) Polyol Compound and Isocyanate Compound

As a set of a polyol compound and an isocyanate compound, used was Polycrystal PC-15 (polyol compound: isocyanate compound=23.32 parts by mass: 25.14 parts by mass), manufactured by Polysis Co., Ltd., or Polycrystal PC-30 (polyol compound: isocyanate compound=23.46 parts by mass: 25.00 parts by mass), manufactured by the same company. Here, the polyol compound was polyoxypolyalkylene polyol. The isocyanate compound was hexamethylene diisocyanate and derivatives thereof.

### (2) Hydroxyl Group-Imparting Additive

As an acrylate monomer as a hydroxyl group-imparting additive, used was pentaerythritol (tri/tetra)acrylate (Name: PETRA), manufactured by Daicel-Allnex Ltd., or hydroxyethyl acrylate (Name: 2-HEA), manufactured by Tokyo Chemical Industry Co., Ltd.

### (3) Polyfunctional Urethane (Meth)Acrylate

As a polyfunctional urethane (meth)acrylate, one of the following was used.
KRM 8904 (manufactured by Daicel-Allnex Ltd., with no residual hydroxyl group, Mw: 1,800)
EBECRYL 9260 (manufactured by Daicel-Allnex Ltd., with no residual hydroxyl group, Mw: 1,500)
EBECRYL 8210 (manufactured by Daicel-Allnex Ltd., with residual hydroxyl group, Mw: 600)
EBECRYL 5129 (manufactured by Daicel-Allnex Ltd., with residual hydroxyl group, Mw: 800)
EBECRYL 4738 (manufactured by Daicel-Allnex Ltd., with no residual hydroxyl group, Mw: 800)
EBECRYL 1290 (manufactured by Daicel-Allnex Ltd., with residual hydroxyl group, Mw: 1,000)

### (4) Photopolymerization Initiator

As a photopolymerization initiator, used was bis(2,4,6-trimethylbenzoyl)phenylphosphine oxide (name: Omnirad 819), manufactured by IGM Resins B. V. (distributor: Toyotsu Chemiplas Corp.), or diphenyl(2,4,6-trimethylbenzoyl)phosphine oxide (name: TPO), manufactured by Chitec Technology Co., Ltd. (distributor: Kusumoto Chemicals, Ltd.).

### 2. Method of Measuring Hardness and Acceptance/Rejection Criterium

The hardness of the photocurable urethane gel-state body after being thermocured and the urethane cured body after being photocured were measured based on JIS K6253 “Rubber, vulcanized or thermoplastic, Determination of hardness” by using a type E durometer (manufactured by Niigata Seiki Co., Ltd., name: ADM-E).

The case where the hardness (referred to as “E hardness”) of the photocurable urethane gel-state body was E1 or higher and E30 or lower was taken as acceptable; and the case of lower than E1 or higher than E30, as rejected. This is because: with the hardness being in the range of E1 or higher and E30 or lower, the photocurable urethane gel-state body became suitable for the cases of being stuffed in screw holes and used as pipe joints, and being used as substitutes for ultraviolet-curable FRP sheets; in particular, in the case of using the gel-state body for attaching a tube in place of a one-touch joint, it was easy for the gel-state body to be stuffed in a screw hole being an attaching objective, and it was also easy for the tube to be inserted into and made to penetrate the gel-state body; and then, due to that the gel-state body had a suitable hardness and was not liquefied and could secure the sealability between the tube and the screw hole, the gel-state body was suitable for applications to pipe joints.

Then, the case where the E hardness of the urethane cured body of the photocurable urethane gel-state body after being photocured was E60 or higher was taken as acceptable; and the case of lower than E60 was taken as rejected. This is because with the hardness being made to be E60 or higher, for example, in the case where the photocurable urethane gel-state body was stuffed in a screw hole; a tube is inserted; and the gel-state body was photocured, a tough pipe joint exhibiting no easy coming-out of the tube and the photocured body and withstanding long-term usage could be obtained.

### 3. Examples

In Table 1, there are shown production conditions and evaluation results of hardness of each Example.

TABLE 1

| | Photocurable resin | | | | Themocurable resin | | | | |
|---|---|---|---|---|---|---|---|---|---|
| | Photopolymerization | | Urethane | | Hydroxyl group- | | Gel raw material | | |
| | initiator | | (meth)acrylate | | imparting additive | | | Polyol | Isocyanate |
| | | parts by | | parts by | | parts by | | parts by | parts by |
| Example | type | mass | type | mass | type | mass | type | mass | mass |
| 1 | 819 | 0.25 | KRM8904 | 49.75 | PETRA | 1.54 | PC-15 | 23.32 | 25.14 |
| 2 | 819 | 0.25 | KRM8904 | 49.75 | PETRA | 1.54 | PC-30 | 23.46 | 25.00 |
| 3 | 819 | 0.15 | KRM8904 | 29.85 | PETRA | 2.16 | PC-15 | 32.65 | 35.20 |
| 4 | 819 | 0.18 | KRM8904 | 34.83 | PETRA | 2.00 | PC-15 | 30.32 | 32.68 |
| 5 | 819 | 0.20 | KRM8904 | 39.80 | PETRA | 1.85 | PC-15 | 27.98 | 30.17 |
| 6 | 819 | 0.23 | KRM8904 | 44.78 | PETRA | 1.69 | PC-15 | 25.65 | 27.65 |
| 7 | 819 | 0.25 | EBECRYL | 49.75 | PETRA | 1.54 | PC-15 | 23.32 | 25.14 |
| | | | 4738 | | | | | | |
| 8 | 819 | 0.25 | EBECRYL | 49.75 | PETRA | 1.54 | PC-15 | 23.32 | 25.14 |
| | | | 9260 | | | | | | |
| 9 | TPO | 1.00 | EBECRYL | 49.00 | HEA | 0.37 | PC-15 | 24.63 | 25.00 |
| | | | 9260 | | | | | | |
| 10 | TPO | 1.00 | KRM8904 | 49.00 | HEA | 0.37 | PC-15 | 24.63 | 25.00 |
| 11 | TPO | 1.00 | EBECRYL | 49.00 | HEA | 0.37 | PC-15 | 24.63 | 25.00 |
| | | | 9260 | | | | | | |
| 12 | TPO | 1.00 | KRM8904 | 49.00 | HEA | 0.37 | PC-15 | 24.63 | 25.00 |
| 13 | TPO | 0.80 | EBECRYL | 39.20 | HEA | 0.44 | PC-15 | 29.56 | 30.00 |
| | | | 9260 | | | | | | |
| 14 | TPO | 1.00 | EBECRYL | 49.00 | HEA | 0.37 | PC-15 | 24.63 | 25.00 |
| | | | 9260 | | | | | | |

| | Irradiation condition | | | | | | | |
|---|---|---|---|---|---|---|---|---|
| | | | | Integrated | | Result | | |
| | Irradiation | Irradiation | Irradiation | light | Irradiation | Curing | | |
| | device | intensity | time | quantity | wavelengt | depth | E hardness | |
| Example | type | mW/cm² | sec | J/cm² | nm | mm | gelation | photocuring |
| 1 | LWK- | 151 | 120 | 18 | visible | 15 | 3 | 81 |
| | 1300Z | | | | light | | | |
| 2 | LWK- | 151 | 120 | 18 | visible | 15 | 10 | 94 |
| | 1300Z | | | | light | | | |
| 3 | LWK- | 151 | 120 | 18 | visible | 15 | 6 | 70 |
| | 1300Z | | | | light | | | |
| 4 | LWK- | 151 | 120 | 18 | visible | 15 | 5 | 79 |
| | 1300Z | | | | light | | | |
| 5 | LWK- | 151 | 120 | 18 | visible | 15 | 4 | 84 |
| | 1300Z | | | | light | | | |
| 6 | LWK- | 151 | 120 | 18 | visible | 15 | 3 | 85 |
| | 1300Z | | | | light | | | |
| 7 | LWK- | 151 | 120 | 18 | visible | 15 | 1 | 88 |
| | 1300Z | | | | light | | | |
| 8 | LWK- | 151 | 120 | 18 | visible | 15 | 3 | 79 |
| | 1300Z | | | | light | | | |
| 9 | ALE/1.1 | 455 | 60 | 27 | 435 | 15 | 3 | 76 |
| 10 | ALE/1.1 | 455 | 70 | 32 | 435 | 15 | 3 | 84 |
| 11 | LWK- | 151 | 240 | 36 | visible | 15 | 3 | 73 |
| | 1300Z | | | | light | | | |
| 12 | LWK- | 151 | 240 | 36 | visible | 15 | 3 | 89 |
| | 1300Z | | | | light | | | |
| 13 | LWK- | 151 | 240 | 18 | visible | 15 | 2 | 67 |
| | 1300Z | | | | light | | | |
| 14 | LWK- | 151 | 240 | 36 | visible | 15 | 3 | 74 |
| | 1300Z | | | | light | | | |

### Example 1

The photocurable composition: the thermocurable composition was made to be 50:50 in mass ratio.

49.75 parts by mass of the polyfunctional urethane (meth)acrylate (KRM 8904), 0.25 part by mass of the photopolymerization initiator (Omnirad 819), 48.46 parts by mass of the “set of a polyol compound and an isocyanate compound (PC-15)”, 1.54 parts by mass of the hydroxyl group-imparting additive (PETRA) and 0.74 part by mass of dehydrated acetone as a solvent were mixed and heated to thereby fabricate a photocurable urethane gel-state body. Here, 1 part by mass was taken to be equivalent to 10 g. The same applied to parts by mass in the following Examples and Comparative Examples. A specific method for producing the photocurable urethane gel-state body was as follows.

First, the photopolymerization initiator was dissolved in the dehydrated acetone, and the solution was added to the polyfunctional urethane (meth)acrylate. The mixture of the photopolymerization initiator, the polyfunctional urethane (meth)acrylate and the dehydrated acetone was heated under stirring in the air at a temperature of 95° C. until bubbles by volatilization of the dehydrated acetone were no longer visually recognized.

Then, the hydroxyl group-imparting additive was added to the polyol compound being a base agent of a polyurethane, and stirred at room temperature. Thereafter, in the stirred material, the isocyanate compound being a curing agent was mixed and stirred. The blend ratio (base agent:curing agent) of the base agent and the curing agent was made to be about 100:108 in mass ratio.

Thereafter, a photocurable composition prepared by mixing the photopolymerization initiator and the polyfunctional urethane (meth)acrylate, and a thermocurable composition prepared by mixing the hydroxyl group-imparting additive, the polyol compound and the isocyanate compound were stirred and mixed, then poured in a silicone resin-made mold, and heated and cured at 100° C. for 2 hours. Then, a gel-state body after the heating was taken out from the mold, and the hardness of the gel-state body was measured. The hardness of the photocurable urethane gel-state body obtained by the thermocuring was E3, and was taken as acceptable.

Then, light irradiation was carried out on the gel-state body from above the gel-state body by using a light irradiation device (type number: LWK-1300Z, using a visible light LED light, illuminance: 1,300 lm, irradiation time: 120 s, for details, see Table 1), manufactured by IRIS Ohyama Inc., to photocure the photocurable urethane gel-state body. After the photocuring, the depth (referred to as curing depth) from the top surface of the gel-state body to which the gel-state body had been cured was measured. As a result, the curing depth was 15 mm, and taken as acceptable. Further, the hardness was E81, and taken as acceptable.

### Example 2

The photocurable composition: the thermocurable composition was made to be 50:50 in mass ratio.

The mixture of a polyol compound and an isocyanate compound was altered from PC-15 to PC-30. Except for the above alteration, a photocurable urethane gel-state body was fabricated under the same condition as in Example 1 and the gel-state body was photocured under the same condition as in Example 1. The hardness of the photocurable urethane gel-state body obtained by thermocuring was E10. The curing depth after the photocuring was 15 mm as in Example 1. The hardness of a cured body after the photocuring was E94. Both the hardness and the curing depth were both on acceptable levels.

### Example 3

The photocurable composition: the thermocurable composition was made to be 30:70 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 1. The thermocuring condition and the photocuring condition thereafter were made to be the same conditions in Example 1, respectively. The hardness of a photocurable urethane gel-state body obtained by the thermocuring was E6. The curing depth after the photocuring was 15 mm as in Example 1. The hardness of a cured body after the photocuring was E70. Both the hardness and the curing depth were both on the acceptable levels.

### Example 4

The photocurable composition: the thermocurable composition was made to be 35:65 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 1. The thermocuring condition and the photocuring condition thereafter were made to be the same conditions in Example 1, respectively. The hardness of a photocurable urethane gel-state body obtained by the thermocuring was E5. The curing depth after the photocuring was 15 mm as in Example 1. The hardness of a cured body after the photocuring was E79. Both the hardness and the curing depth were both on the acceptable levels.

### Example 5

The photocurable composition: the thermocurable composition was made to be 40:60 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 1. The thermocuring condition and the photocuring condition thereafter were made to be the same conditions in Example 1, respectively. The hardness of a photocurable urethane gel-state body obtained by the thermocuring was E4. The curing depth after the photocuring was 15 mm as in Example 1. The hardness of a cured body after photocuring was E84. Both the hardness and the curing depth were both on the acceptable levels.

### Example 6

The photocurable composition: the thermocurable composition was made to be 45:55 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 1. The thermocuring condition and the photocuring condition thereafter were made to be the same conditions in Example 1, respectively. The hardness of a photocurable urethane gel-state body obtained by the thermocuring was E3. The curing depth after the photocuring was 15 mm as in Example 1. The hardness of a cured body after the photocuring was E85. Both the hardness and the curing depth were both on the acceptable levels.

### Example 7

The photocurable composition: the thermocurable composition was made to be 50:50 in mass ratio.

The polyfunctional urethane (meth)acrylate was altered from KRM 8904 to EBECRYL 4738. Except for the above alteration, a photocurable urethane gel-state body was fabricated under the same condition as in Example 1 and the gel-state body was photocured under the same condition as in Example 1. The hardness of the photocurable urethane gel-state body obtained by the thermocuring was E1. The curing depth after the photocuring was 15 mm as in Example 1. The hardness of a cured body after the photocuring was E88. Both the hardness and the curing depth were both on acceptable levels.

### Example 8

The photocurable composition: the thermocurable composition was made to be 50:50 in mass ratio.

The polyfunctional urethane (meth)acrylate was altered from KRM 8904 to EBECRYL 9260. Except for the above alteration, a photocurable urethane gel-state body was fabricated under the same condition as in Example 1 and the gel-state body was photocured under the same condition as in Example 1. The hardness of the photocurable urethane gel-state body obtained by the thermocuring was E3. The curing depth after the photocuring was 15 mm as in Example 1. The hardness of a cured body after the photocuring was E79. Both the hardness and the curing depth were both on acceptable levels.

### Example 9

The photocurable composition: the thermocurable composition was made to be 50:50 in mass ratio.

49.00 parts by mass of the polyfunctional urethane (meth)acrylate (EBECRYL 9260), 1.00 part by mass of the photopolymerization initiator (TPO), 49.63 parts by mass of the “mixture of a polyol compound and an isocyanate compound (PC-15)”, 0.37 part by mass of the hydroxyl group-imparting additive (HEA) and 0.74 part by mass of dehydrated acetone as a solvent were mixed and heated to thereby fabricate a photocurable urethane gel-state body. The hardness of the photocurable urethane gel-state body obtained by the thermocuring was E3. The curing depth after the thermocuring was 15 mm as in Example 1. Thereafter, the photocurable urethane gel-state body was photocured by using a light irradiation device (type number: ALE/1.1, wavelength of light: 435 nm), manufactured by KLV Co., Ltd., whose light output was higher than that of the light irradiation device used in Example 1, under the condition of the irradiation intensity: 455 mW/cm², the irradiation time: 60 s, and the integrated light quantity: 27 J/cm². The hardness of a cured body after the photocuring was E76. Both the hardness and the curing depth were both on acceptable levels.

### Example 10

The photocurable composition: the thermocurable composition was made to be 50:50 in mass ratio.

The polyfunctional urethane (meth)acrylate was altered from EBECRYL 9260 to KRM 8904. Except for the above alteration, a photocurable urethane gel-state body was fabricated under the same condition as in Example 9. The hardness of the photocurable urethane gel-state body obtained by the thermocuring was E3. The curing depth after photocuring was 15 mm as in Example 1. Thereafter, the photocurable urethane gel-state body was photocured by using the light irradiation device (type number: ALE/1.1, wavelength of light:435 nm) used in Example 9 under the condition of the irradiation intensity: 455 mW/cm², the irradiation time: 70 s, and the integrated light quantity: 32 J/cm². The hardness of a cured body after the photocuring was E84. Both the hardness and the curing depth were both on acceptable levels.

### Example 11

The photocurable composition: the thermocurable composition was made to be 50:50 in mass ratio.

A photocurable urethane gel-state body was fabricated under the same condition as in Example 9. The hardness of the photocurable urethane gel-state body obtained by the thermocuring was E3. The curing depth after photocuring was 15 mm as in Example 1. Thereafter, the photocurable urethane gel-state body was photocured by using a light irradiation device (type number: LWK-1300Z, using a visible light LED light, illuminance: 1,300 lm, irradiation time: 240 s, for details, see Table 1), manufactured by IRIS Ohyama Inc. The hardness of a cured body after the photocuring was E73. Both the hardness and the curing depth were both on acceptable levels.

### Example 12

The photocurable composition: the thermocurable composition was made to be 50:50 in mass ratio.

A photocurable urethane gel-state body was fabricated under the same condition as in Example 10. The hardness of the photocurable urethane gel-state body obtained by the thermocuring was E3. The curing depth after photocuring was 15 mm as in Example 1. Thereafter, the photocurable urethane gel-state body was photocured under the same condition as in Example 11. The hardness of a cured body after the photocuring was E89. Both the hardness and the curing depth were both on acceptable levels.

### Example 13

The photocurable composition: the thermocurable composition was made to be 40:60 in mass ratio.

Each amount of the polyfunctional urethane (meth)acrylate (EBECRYL 9260), the photopolymerization initiator (TPO), the mixture of a polyol compound and an isocyanate compound (PC-15) and the hydroxyl group-imparting additive (HEA) was as indicated in Table 1. The hardness of a photocurable urethane gel-state body obtained by thermocuring was E2. The curing depth after photocuring was 15 mm as in Example 1. Thereafter, the photocurable urethane gel-state body was photocured by using the device used in Example 11 under the irradiation condition indicated in Table 1. The hardness of a cured body after the photocuring was E67. Both the hardness and the curing depth were both on the acceptable levels.

### Example 14

The photocurable composition: the thermocurable composition was made to be 50:50 in mass ratio.

A photocurable urethane gel-state body was fabricated under the same condition as in Example 9. The hardness of the photocurable urethane gel-state body obtained by the thermocuring was E3. The curing depth after photocuring was 15 mm as in Example 1. Thereafter, the photocurable urethane gel-state body was photocured under the same condition as in Example 11. The hardness of a cured body after the photocuring was E74. Both the hardness and the curing depth were both on acceptable levels.

### 4. Comparative Examples

In Table 2, there are shown production conditions and evaluation results of hardness of each Comparative Example.

TABLE 2

| | | | | | Themocurable resin | | | | |
|---|---|---|---|---|---|---|---|---|---|
| | | | | | Hydroxyl | | | | |
| | Photocurable resin | | | | group- | | | | |
| | Photopolymerization | | Urethane | | imparting | | Gel raw material | | |
| | initiator | | (meth)acrylate | | additive | | | Polyol | Isocyanate |
| Comparative | | parts by | | parts by | | parts by | | parts by | parts by |
| Example | type | mass | type | mass | type | mass | type | mass | mass |
| 1 | 819 | 0.03 | KRM8904 | 4.98 | PETRA | 0.03 | PC-15 | 44.31 | 47.77 |
| 2 | 819 | 0.05 | KRM8904 | 9.95 | PETRA | 0.03 | PC-15 | 41.98 | 45.25 |
| 3 | 819 | 0.33 | KRM8904 | 64.68 | PETRA | 0.01 | PC-15 | 16.32 | 17.60 |
| 4 | 819 | 0.35 | KRM8904 | 69.65 | PETRA | 0.01 | PC-15 | 13.99 | 15.08 |
| 5 | 819 | 0.25 | EBECRYL | 49.75 | PETRA | 0.02 | PC-15 | 23.32 | 25.14 |
| | | | 5129 | | | | | | |
| 6 | 819 | 0.25 | EBECRYL | 49.75 | PETRA | 0.02 | PC-15 | 23.32 | 25.14 |
| | | | 8210 | | | | | | |
| 7 | 819 | 0.25 | EBECRYL | 49.75 | PETRA | 0.02 | PC-15 | 23.32 | 25.14 |
| | | | 1290 | | | | | | |
| 8 | 819 | 0.28 | KRM8904 | 54.73 | PETRA | 0.01 | PC-15 | 20.99 | 22.63 |
| 9 | 819 | 0.30 | KRM8904 | 59.70 | PETRA | 0.01 | PC-15 | 18.66 | 20.11 |
| 10 | TPO | 0.40 | EBECRYL | 19.60 | HEA | 0.01 | PC-15 | 39.41 | 40.00 |
| | | | 9260 | | | | | | |
| 11 | TPO | 1.40 | EBECRYL | 68.60 | HEA | 0.00 | PC-15 | 14.78 | 15.00 |
| | | | 9260 | | | | | | |
| 12 | TPO | 1.20 | EBECRYL | 58.80 | HEA | 0.00 | PC-15 | 19.70 | 20.00 |
| | | | 9260 | | | | | | |

| | Irradiation condition | | | | | | | |
|---|---|---|---|---|---|---|---|---|
| | | | | Integrated | | Result | | |
| | Irradiation | Irradiation | Irradiation | light | Irradiation | Curing | | |
| Comparative | device | intensity | time | quantity | wavelengt | depth | E hardness | |
| Example | type | mW/cm² | sec. | J/cm² | nm | mm | gelatin | photocuring |
| 1 | LWK- | 151 | 120 | 18 | visible | 15 | 15 | 38 |
| | 1300Z | | | | light | | | |
| 2 | LWK- | 151 | 120 | 18 | visible | 15 | 12 | 50 |
| | 1300Z | | | | light | | | |
| 3 | — | — | — | — | — | — | liquidity | — |
| 4 | — | — | — | — | — | — | liquidity | — |
| 5 | — | — | — | — | — | — | liquidity | — |
| 6 | — | — | — | — | — | — | liquidity | — |
| 7 | — | — | — | — | — | — | liquidity | — |
| 8 | — | — | — | — | — | — | liquidity | — |
| 9 | — | — | — | — | — | — | liquidity | — |
| 10 | LWK- | 151 | 240 | 36 | visible | 15 | 4 | 51 |
| | 1300Z | | | | light | | | |
| 11 | — | — | — | — | — | — | liquidity | — |
| 12 | LWK- | 151 | 240 | 36 | visible | 15 | <1 | 83 |
| | 1300Z | | | | light | | | |

### Comparative Example 1

The photocurable composition: the thermocurable composition was made to be 5:95 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 2. The thermocuring condition and the photocuring condition thereafter were made to be the same conditions in Example 1, respectively. The hardness of a photocurable urethane gel-state body obtained by the thermocuring was E15. The curing depth after the photocuring was 15 mm as in Example 1. The gel-state body satisfied the acceptable criteria. However, the hardness of a cured body after the photocuring was E38, which did not reach the acceptable level.

### Comparative Example 2

The photocurable composition: the thermocurable composition was made to be 10:90 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 2. The thermocuring condition and the photocuring condition thereafter were made to be the same conditions in Example 1, respectively. The hardness of a photocurable urethane gel-state body obtained by the thermocuring was E12. The curing depth after the photocuring was 15 mm as in Example 1. The gel-state body satisfied the acceptable criteria. However, the hardness of a cured body after the photocuring was E50, which did not reach the acceptable level.

### Comparative Example 3

The photocurable composition: the thermocurable composition was made to be 65:35 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 2. Although the thermocuring condition was made to be the same as in Example 1, the resultant was not cured even by being heated (having liquidity). Hence, the light irradiation thereafter was not carried out.

### Comparative Example 4

The photocurable composition: the thermocurable composition was made to be 70:30 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 2. Although the thermocuring condition was made to be the same as in Example 1, the resultant was not cured even by being heated (having liquidity). Hence, the light irradiation thereafter was not carried out.

### Comparative Example 5

The photocurable composition: the thermocurable composition was made to be 50:50 in mass ratio.

The polyfunctional urethane (meth)acrylate was altered from KRM 8904 to EBECRYL 5129. Except for the above alteration, the condition was made to be the same as in Example 1. Although the thermocuring condition was made to be the same as in Example 1, the resultant was not cured even by being heated (having liquidity). Hence, the light irradiation thereafter was not carried out.

### Comparative Example 6

The photocurable composition: the thermocurable composition was made to be 50:50 in mass ratio.

The polyfunctional urethane (meth)acrylate was altered from KRM 8904 to EBECRYL 8210. Except for the above alteration, the condition was made to be the same as in Example 1. Although the thermocuring condition was made to be the same as in Example 1, the resultant was not cured even by being heated (having liquidity). Hence, the light irradiation thereafter was not carried out.

### Comparative Example 7

The photocurable composition: the thermocurable composition was made to be 50:50 in mass ratio.

The polyfunctional urethane (meth)acrylate was altered from KRM 8904 to EBECRYL 1290. Except for the above alteration, the condition was made to be the same as in Example 1. Although the thermocuring condition was made to be the same as in Example 1, the resultant was not cured even by being heated (having liquidity). Hence, the light irradiation thereafter was not carried out.

### Comparative Example 8

The photocurable composition: the thermocurable composition was made to be 55:45 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 2. Although the thermocuring condition was made to be the same as in Example 1, the resultant was not cured even by being heated (having liquidity). Hence, the light irradiation thereafter was not carried out.

### Comparative Example 9

The photocurable composition: the thermocurable composition was made to be 60:40 in mass ratio.

Each amount of the polyfunctional urethane (meth)acrylate (KRM 8904), the photopolymerization initiator (Omnirad 819), the mixture of a polyol compound and an isocyanate compound (PC-15) and the hydroxyl group-imparting additive (PETRA) was as indicated in Table 2. Although the thermocuring condition was made to be the same as in Example 1, the resultant was not cured even by being heated (having liquidity). Hence, the light irradiation thereafter was not carried out.

### Comparative Example 10

The photocurable composition: the thermocurable composition was made to be 20:80 in mass ratio.

19.60 parts by mass of the polyfunctional urethane (meth)acrylate (EBECRYL 9260), 0.40 part by mass of the photopolymerization initiator (TPO), 79.41 parts by mass of the “mixture of a polyol compound and an isocyanate compound (PC-15)”, 0.59 part by mass of the hydroxyl group-imparting additive (HEA) and 0.74 part by mass of dehydrated acetone as a solvent were mixed and heated as in Example 1 to thereby fabricate a photocurable urethane gel-state body. The hardness of the photocurable urethane gel-state body obtained by the thermocuring was E4. The curing depth after photocuring was 15 mm as in Example 1. The gel-state body satisfied the acceptable criteria. Thereafter, the photocurable urethane gel-state body was photocured under the same condition as in Example 11. However, the hardness of a cured body after the photocuring was E51, which did not reach the acceptable level.

### Comparative Example 11

The photocurable composition: the thermocurable composition was made to be 70:30 in mass ratio.

The kinds of raw materials were made to be the same as in Comparative Example 10, and the amounts of each raw material were altered as indicated in Table 2. Thereafter, the resultant was heated by the same condition as in Example 1, but the resultant was not cured (having liquidity). Hence, the light irradiation was not carried out.

### Comparative Example 12

The photocurable composition: the thermocurable composition was made to be 60:40 in mass ratio.

The kinds of raw materials were made to be the same as in Comparative Example 10, and the amounts of each raw material were altered as indicated in Table 2. Thereafter, the resultant was heated by the same condition as in Example 1, but the hardness was too soft to such a degree that it did not reach E1. Hence, the hardness of the gel-state body did not reach the acceptable level. Thereafter, the resultant was irradiated with light under the same condition as in Comparative Example 10; as a result, the hardness of a cured body was E83.

### INDUSTRIAL APPLICABILITY

The present invention can be utilized as, in addition to pipe joints, repairing members for piping and building materials.

1. A photocurable urethane gel-state body, comprising, at least:
a photocurable composition (A) comprising a polyfunctional urethane (meth)acrylate and a photopolymerization initiator; and
a polyurethane (B),
wherein the photocurable composition (A): the polyurethane (B) is, in mass ratio, in the range of 25:75 to 55:45; and
the polyfunctional urethane (meth)acrylate has no residual hydroxyl group.

2. The photocurable urethane gel-state body of claim 1, wherein the photocurable composition (A): the polyurethane (B) is, in mass ratio, in the range of 41:59 to 50:50.

3. The photocurable urethane gel-state body of claim 1, wherein a weight-average molecular weight (Mw) of the polyfunctional urethane (meth)acrylate is 1,500 or higher and 2,000 or lower.

4. The photocurable urethane gel-state body of claim 1, wherein the photopolymerization initiator is a bisacylphosphine oxide-based photopolymerization initiator.

5. The photocurable urethane gel-state body of claim 1, wherein a hardness of the gel-state body by a type E durometer based on JIS K6253 is E3 or higher and E10 or lower; and
a hardness of the gel-state body after being photocured by a type E durometer based on JIS K6253 becomes E75 or higher.

6. A method for producing a photocurable urethane gel-state body of claim 1, the method comprising using:
a photocurable composition comprising a polyfunctional urethane (meth)acrylate and a photopolymerization initiator; and
a thermocurable composition comprising, at least, a polyol compound, an isocyanate compound and an acrylate monomer as a hydroxyl group-imparting additive,
wherein the photocurable composition: the thermocurable composition is, in mass ratio, in the range of 25:75 to 55:45, and
the method comprising:
a mixing step of mixing the thermocurable composition and the photocurable composition to prepare a mixture; and
a thermocuring step of thermocuring the mixture after the mixing step.

7. The method for producing a photocurable urethane gel-state body of claim 6, wherein the photocurable composition: the thermocurable composition is, in mass ratio, in the range of 41:59 to 50:50.

8. The method for producing a photocurable urethane gel-state body of claim 6, wherein the acrylate monomer is hydroxyethyl acrylate and/or pentaerythritol (tri/tetra)acrylate.
